(19) United States
(12) Patent Application Publication
(10) Pub. No.: US 2018/0339291 A1
(43) Pub. Date: Nov. 29, 2018

(54) Digital Titrator

(71) Applicants: Jose Felix Manfredi, Jundiai (BR); Marcelo Texeira Duarte, Campinas (BR); Karel Negrin Napoles, Sao Carlos (BR)

(72) Inventors: Jose Felix Manfredi, Jundiai (BR); Marcelo Texeira Duarte, Campinas (BR); Karel Negrin Napoles, Sao Carlos (BR)

(21) Appl. No.: 15/757,755

(22) PCT Filed: Sep. 9, 2016
(86) PCT No.: PCT/BR2016/000095

§ 371 Date: Mar. 6, 2018

(30) Foreign Application Priority Data
Sep. 10, 2015 (BE) 10 2015 024863-6

(51) Int. Cl. B01L 3/02; G06F 19/00

(52) U.S. Cl. CPC B01L 3/0241; G06F 19/00

(57) ABSTRACT

“DIGITAL TITRATOR”, for application in chemical instrumental analysis, comprising a transparent vertical tube (burette) (1), which contains the titrant, monitored by a contact image sensor (CIS) (2), parallel to the tube. A titrant reservoir (3) communicates with said burette, with solution transfer by means of a pump (4). The release of said solution is made by a valve (5) to the reaction flask (6), where a sensor (7) collects and transmits information about the progress of monitored reaction to a computer (8). Analytical data is stored, processed and displayed to the user on a screen, and/or printed. A flexible tube communicates the upper ends of tube and reservoir and transfers saturated internal atmosphere conversely, according as pressure change, caused by meniscus movement, without gas exchange with atmosphere, preventing evaporation of solvent and consequent changes in titrant concentration. For the same purpose, the inlet air from atmosphere to the reservoir goes by a saturation bottle (9) containing pure solvent. A PCI (10) controls operations, assisted by a computer, and an agitator (11) homogenizes reaction flask's content.

This patent request concerns to a digital titrator, for quantitative chemical analysis, among other applications, which uses the innovative concept of reading the meniscus position in a vertical tube by means of a contact image sensor (CIS) [1], and combines the traditional advantages of automatic titrators with the innovative features of an instrument that does not have the mechanical complexities of those. CIS sensors are used in scanners, code bar readers and in optical identification devices and are distinguished by its high resolution, small size, low power consumption and portability. CIS sensors typically consist of linear arrays of detectors, equipped with focalizing lenses and LED lighting of various colors, and contain ail optical elements in a functional module.

Titration [2] is a quantization technique of chemical species in solution by adding a reagent (titrant), of known concentration, in a reproducible reaction of known stoichiometry. The technique is used for analysis of acids, bases, oxidants, reducing agents, metal ions, proteins, and others. Industry uses it for control of raw materials, processes, products and liquid effluents. The advantages are many and, in several applications, there is no viable alternative in convenience, speed and cost. It highlights the precision, better than most instrumental methods, the fact of dispensing with frequent calibration, low cost per analysis, possibility of automation and calibration of routine analysis validation made by other means.

Procedure quantification is a direct relationship between volumes and molarities,

C_{a·}Vₐ=C_{b·}V_{b}

being Cₐ the molar concentration of solution A, Vₐ the volume of solution A, C_{b} the molar concentration of solution B and V_{b} the volume of solution B.

Addition of titrant is completed when the end of reaction (end point) is detected and it is always used a chemical or instrumental means of detection that brings about the end point as close as possible to the reaction stoichiometric ratio (equivalence point).

A titration may be conducted directly to the end point, or by intervals, so as to generate a curve of values of monitored property against consumed titrant volume. A graph allows the identification of the equivalence point by mathematical procedures, such as derivatives [3] or extrapolation [4].

Instrumental titration [5] is usual in analytical centers, with different automation degrees, for routine analysis or research. Its main advantages are precision, accuracy and versatility, and disadvantages of current instruments are initial and maintenance costs, due to complex mechanical components. Most common type uses a piston, driven by high precision electric motor, to drive the titrant, and consumed volume corresponds to volume displacement of piston. An alternative model [6] expels titrant by compression of a plastic cartridge, by rotary spindle. Peristaltic pumps are suitable to propel solution, but are less accurate than piston pumps [7]. Gravimetric versions [8,9] use mass sensors, such as load cells or strain gages, to measure titrant consumption. Usual sensors are potentiometric electrodes, electrometric cells and optical cells.

Current titrators have different performance ranges and prices, contemplating software and hardware resources. One common item is a volumetric burette, with a mechanical structure, more or less complex, that contribute to the accuracy by controlling the titrant volume transferred to reaction vessel Using accurate motors and efficient seals is critical for performance and accounts for a significant fraction of acquisition and maintenance costs.

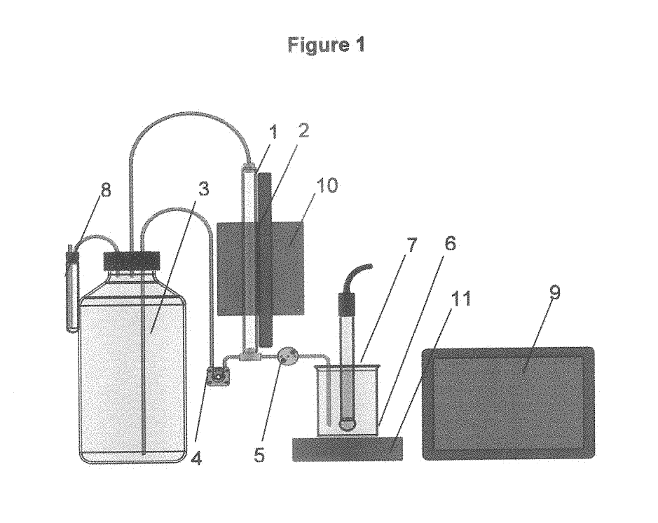

FIG. 1 shows a preferred construction of proposed digital titrator. The instrument detects meniscus position in a transparent vertical tube by means of a high resolution contact image sensor (CIS). It comprises said vertical transparent tube (burette) (1), which contains the titrant monitored by a contact image sensor (2), parallel to the tube. A titrant reservoir (3) communicates with said burette with solution transfer by a pump (4), and release is controlled by an electromechanical valve (5) to the reaction flask (6), wherein a sensor (7) collects and transmits information on reaction progress to the computer (8). Analytical data is stored, processed and displayed to the user on a screen, and/or printed. A communication between the upper end of said burette and the top of said reservoir transfers saturated internal atmosphere conversely, as pressure changes due to meniscus movement, without gas exchange with atmosphere, preventing evaporation of solvent and consequent changes in titrant concentration. For the same purpose, inlet air from atmosphere to the reservoir goes through a saturation bottle (9) containing pure solvent. A PCI (10) controls operations, assisted by a computer, and an agitator (11) homogenizes reaction vessel's content.

Adoption of image sensor as reading system eliminates moving parts that usually are determinant of instrument's accuracy, while pump and valve are used only to titrant transfer, resulting in a device with no mechanical complexity and low cost. Resulting volumetric burette eliminates procedures for mechanical calibration and maintenance related to accuracy. The CIS sensor has low cost and long life.

### CONSULTED REFERENCES

1. Kuroda, T., Essential Principles of Image Sensors, CRC Press: Boca Raton (Fla.), 2014.

2. Harvey, D. T., Modern Analytical Chemistry, 1^{st} ed., McGraw-Hill: New York, 1999, p. 273.

3. Carter K. N., Huff, R. B., Second derivative curves and end-point determination, J. Chem. Educ., 1979, 56 (1), p 26.

4. Gran, G, Analyst, 77, 661 (1952).

5. Oehme, F, Richter, W. Instrumental Titration Techniques. Verlag: Heidelberg, 1987.

6. Hach C. C., Digital Titration Device, U.S. Pat. No. 088,062 A, Apr. 26, 1978, Hach Chemical Co.

7. Hoffmann, W., Computer controlled titration with piston burette or peristaltic pump—a comparison, Fresenius' Journal of Analytical Chemistry, 1996, 356 (3-4), pp 303-305.

8. Zimmerli, F. H., Automatic gravimetric titrator for batch operation, U.S. Pat. No. 3,447,906 A, Jun. 3, 1969, Rohm & Haas.

9. Skoog, D. A., West, D. M., Holler, F. J., Fundamentals of Analytical Chemistry, 6^{th} Edition, Saunders: Philadelphia, 1992; pages 94, 113-114, 809-810, 841-842.

1) “DIGITAL TITRATOR”, instrument for chemical analysis, particularly applicable to quantitative determination of chemical species by volumetry, provided with titrant solution reservoir, volumetric burette, reaction vessel and controlled transfer means of said solution, characterized by the fact that it presents a contact image sensor for reading of liquid column level contained in the burette.

2) “DIGITAL TITRATOR”, instrument for chemical analysis, particularly applicable to quantitative determination of chemical species by volumetry, characterized by the fact that it presents, in accordance with claim 1, a pump for transfer of said titrant between said reservoir and burette.

3) “DIGITAL TITRATOR” instrument for chemical analysis, particularly applicable to quantitative determination of chemical species by volumetry, characterized by the fact that it presents, in accordance with claim 1, an electromechanical valve for controlling the transfer of said titrant from burette into reaction vessel.

4) “DIGITAL TITRATOR”, instrument for chemical analysis, particularly applicable to quantitative determination of chemical species by volumetry, characterized by the fact that it presents, in accordance with claim 1, a connecting means to exchange internal atmosphere between said reservoir and burette.

5) “DIGITAL TITRATOR”, instrument for chemical analysis, particularly applicable to quantitative determination of chemical species by volumetry, characterized by the fact that it presents, in accordance with claim 1, means to saturate external air admitted into reservoir with solvent vapor.
